(19) United States
(12) Patent Application Publication
(10) Pub. No.: US 2010/0122998 A1
(43) Pub. Date: May 20, 2010

(54) Carton With Curved Panels And Opening Tab

(76) Inventor: Bradley J. Burke, Glendale Heights, IL (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/621,030

(22) Filed: Nov. 18, 2009

Related U.S. Application Data
(60) Provisional application No. 61/199,682, filed on Nov. 19, 2008.

(51) Int. Cl. B65D 5/46; B65D 17/28; B65D 25/54; B31B 1/14; B65D 17/00

(52) U.S. Cl. 229/117.12; 229/204; 229/162.1; 493/56; 229/245

(57) ABSTRACT

A blank, carton, or package that includes a dispensing panel is described. The dispensing panel is detachable along tear lines to create an opening in the carton to allow removal of product from the carton. The dispensing panel including a dispensing panel projection and edge projections are provided along a panel parallel the dispensing panel. The dispensing panel projection and the edge projections form a stand feature that allows the carton to be disposed in an upright configuration. The carton can include a viewing opening, which can be covered with a substantially transparent material, and which can provide viewing access to product in the carton.

### CROSS-REFERENCE TO RELATED APPLICATION

This application claims the benefit of U.S. Provisional Application No. 61/199,682, which was filed on Nov. 19, 2008.

### INCORPORATION BY REFERENCE

U.S. Provisional Application No. 61/199,682, which was filed on Nov. 19, 2008, is hereby incorporated by reference for all purposes as if presented herein in its entirety.

### BACKGROUND OF THE DISCLOSURE

Cartons are useful for holding and transporting articles. In order to facilitate dispensing of articles from a carton, it is beneficial to form a dispenser with a portion of the carton.

### SUMMARY OF THE DISCLOSURE

The present disclosure generally relates to blanks, packages, or cartons for holding and/or dispensing product.

In one aspect, the present invention includes a blank with a first panel connected along a first fold line to a second panel, the second panel is connected along a second fold line to a third panel, the third panel is connected along a first line of disruption to a fourth panel, and the fourth panel is connected along a third fold line to an adhesive panel. The first panel includes a peripheral edge with at least one end projection. The blank includes end flaps connected along a first end and along a second end. The blank also includes a dispensing panel in the third panel defined by tear lines and a dispensing panel projection that extends across the first line of disruption into the fourth panel.

The end flaps of the blank can include a first end flap at the first end connected along a first transverse fold line to the first panel, a second end flap at the second end connected along a second transverse fold line to the first panel, a third end flap at the first end connected along a first curved fold line to the second panel, a fourth end flap at the second end connected along a second curved fold line to the second panel, a fifth end flap at the first end connected along a second line of disruption to the third panel, a sixth end flap at the second end connected along a third line of disruption to the third panel, a seventh end flap at the first end connected along a third curved fold line to the fourth panel, and an eighth end flap at the second end connected along a fourth curved fold line to the fourth panel. The tear lines can include a first tear line that extends along the second line of disruption and a second tear line that extends along the third line of disruption. The tear lines can also include a third tear line that extends from the second line of disruption in the third panel in a first direction toward the dispensing panel projection and a fourth tear line that extends from the third line of disruption in the third panel in a second direction toward the dispensing panel projection. The third panel can also include two remainder portions, with a first remainder portion defined between the third tear line, the first line of disruption, and the second line of disruption and a second remainder portion defined between the fourth tear line, the first line of disruption, and the third line of disruption. The blank can also include an opening formed in the second panel. The opening can be covered by a substantially transparent material.

In another aspect, the invention includes a method of dispensing that includes providing a carton. The carton includes a first panel connected along a first fold line to a second panel, the second panel is connected along a second fold line to a third panel, the third panel is connected along a first line of disruption to a fourth panel, and the fourth panel is connected along a third fold line to an adhesive panel. A peripheral edge of the first panel includes at least one end projection. The carton also includes end flaps connected along a first end and along a second end. The carton further includes a dispensing panel in the third panel defined by tear lines and a dispensing panel projection that extends across the first line of disruption into the fourth panel. The method also includes folding the first panel, the second panel, the third panel, the fourth panel, and the adhesive panel along the first fold line, the second fold line, the first line of disruption, and the third fold line, respectively. The method further includes folding the end flaps to close the first end and the second end, and, separating the dispensing panel along the tear lines to create a dispensing opening in the third panel.

Further, the step of separating the dispensing panel can include lifting the dispensing panel projection in a direction away from the dispensing opening. Further still, the carton can include a viewing opening in the second panel. The viewing opening can be covered by a substantially transparent material that allows viewing of the interior of the carton.

In yet another aspect, the invention includes a carton that includes a first panel connected along a first fold line to a second panel, the second panel is connected along a second fold line to a third panel, the third panel is connected along a first line of disruption to a fourth panel, the fourth panel is connected along a third fold line to an adhesive panel, a first end panel formed by end flaps is connected along a first end, and a second end panel is connected along a second end. The first panel of the carton has a peripheral edge that includes at least one end projection. The carton also includes a dispensing panel in the third panel defined by tear lines and a dispensing panel projection that extends across the first line of disruption into the fourth panel. The adhesive panel is connected to an underside of the first panel.

The third panel of the carton can be connected to the first end panel along a second line of disruption and the third panel can be connected to the second end panel along a third line of disruption. The tear lines can also include a first tear line that extends along the second line of disruption and a second tear line that extends along the third line of disruption. Further, the tear lines can include a third tear line that extends from the second line of disruption in the third panel in a first direction toward the dispensing panel projection and a fourth tear line that extends from the third line of disruption in the third panel in a second direction toward the dispensing panel projection. Further still, the third panel can also include two remainder portions with a first remainder portion defined between the third tear line, the first line of disruption, and the second line of disruption and a second remainder portion defined between the fourth tear line, the first line of disruption, and the third line of disruption. Even further, the carton can include a viewing opening in the second panel covered by a substantially transparent material that allows viewing of the interior of the carton. The at least one end projection and the dispensing panel projection can be configured to form stands to support the carton in an upright configuration. The first end and the second end can be formed by end flaps connected to the first panel, the second panel, the third panel, and the fourth panel. The end flaps can be connected along curved fold lines to the second panel and the fourth panel. The end flaps can form a first handle at the first end and a second handle at the second end.

Those skilled in the art will appreciate the above stated advantages and other advantages and benefits of various additional embodiments upon reading the following detailed description of the exemplary embodiments with reference to the below listed drawing figures.

According to common practice, the various features of the drawings discussed below are not necessarily drawn to scale. Dimensions of various features and elements in the drawings may be expanded or reduced to illustrate more clearly the embodiments of the disclosure.

### BRIEF DESCRIPTION OF THE DRAWINGS

FIG. 1 is a plan view of a carton blank.

FIGS. 2 and 3 show the blank of FIG. 1 folded in a preform or shipping configuration prior to being erected into a carton.

FIG. 4 shows a carton formed from the blank of FIG. 1 in a closed configuration.

FIG. 5 shows the carton of FIG. 4 supported on a front edge of the bottom panel and on tabs or projections along a front edge of the top panel.

FIG. 6 shows the carton of FIG. 4 in a display configuration with a lid opened.

Corresponding parts are designated by corresponding reference numbers throughout the drawings.

### DETAILED DESCRIPTION OF THE EXEMPLARY EMBODIMENTS

This disclosure generally relates to cartons suitable for storing and dispensing contents or articles, methods of erecting such cartons from a carton blank, and methods of dispensing from the formed carton. For purposes of illustration and not limitation, the detailed description below describes several embodiments of the invention within the context of a carton with an opener for dispensing contents or articles from the carton. Further, references herein to “end,” “side,” “front,” “rear,” “bottom,” and “top” refer to orientations or positions of elements when the carton is erected and/or disposed in an upright orientation. The terms “upper,” “lower,” “vertical,” “horizontal,” and “oblique,” and any variations thereof, generally refer to the location and/or orientation of an element or line with respect to a drawing figure in which it appears. Reference characters shared among the various embodiments disclosed herein indicate similar parts.

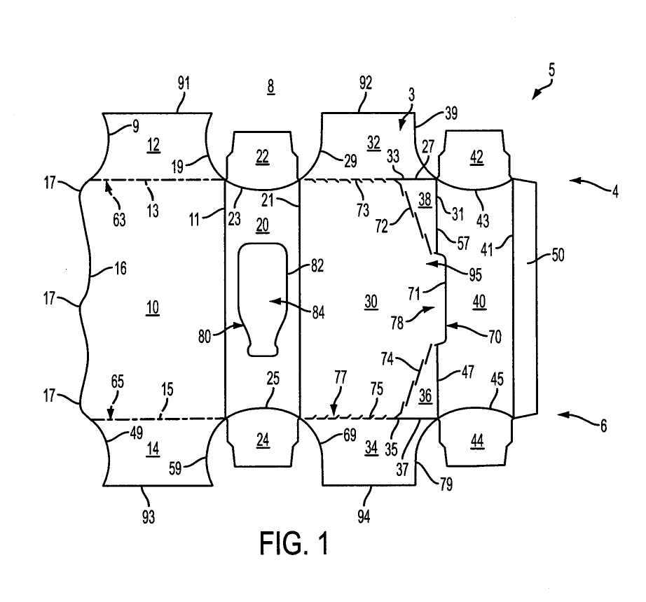

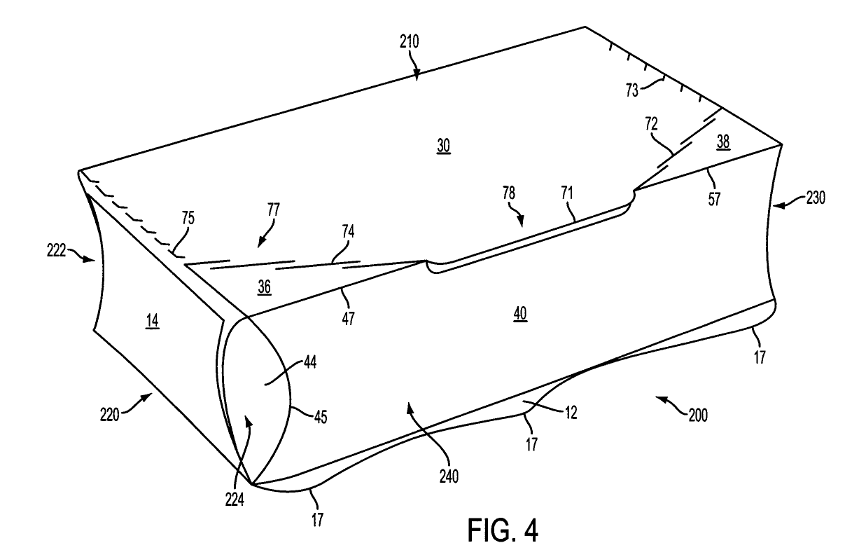

FIG. 1 illustrates an outside facing surface 3 of a carton blank 5 from which a carton 200 (FIGS. 4-8) can be erected. The blank 5 includes a first side panel 10, a second side panel 20, a third side panel 30, a fourth side panel 40, and an adhesive panel 50. Panel 10 is foldably connected along fold line 11 to panel 20, panel 20 is foldably connected along fold line 21 to panel 30, panel 30 is foldably connected along line of disruption 31 to panel 40, and panel 40 is foldably connected along fold line 41 to adhesive panel 50. End flap 12 is connected along a fold line 13 to a first end 4 of panel 10. End flap 12 is defined between arcuate lines 9 and 19, fold line 13, and edge 91. End flap 14 is foldably connected along a fold line 15 to a second end 6 of panel 10. End flap 14 is defined between arcuate lines 49 and 59, fold line 15, and edge 93. End flap 22 is connected along a fold line 23 to the first end 4 of panel 20. End flap 24 is foldably connected along a fold line 25 to the second end 6 of panel 20. Fold lines 23 and 25 are arcuate fold lines that form concave side edges of panel 20. End flap 32 is connected along line of disruption 33 to the first end 4 of panel 30. End flap 32 is defined between arcuate lines 29 and 39, segment line 27 and tear line 73 that comprise line of disruption 33, and edge 92. End flap 34 is foldably connected along a line of disruption 35 to the second end 6 of panel 30. End flap 34 is defined between arcuate lines 69 and 79, segment line 37 and tear line 75 that comprise line of disruption 35, and edge 94. End flap 42 is connected along a fold line 43 to the first end 4 of panel 40. End flap 44 is foldably connected along a fold line 45 to the second end 6 of panel 40. Fold lines 43 and 45 are arcuate fold lines that form concave side edges of panel 40. Fold lines 13, 15, 33, 35 are generally transverse to fold lines 11, 21, 31, 41. One or more of fold lines 13, 23, 33, 43 could be replaced by a single fold line, such as indicated at 63, and one or more of fold lines. One or more of fold lines 15, 25, 35, 45 could be replaced by a single fold line, such as indicated at 65. End flaps 12, 14, 22, 24, 32, 34, 42, 44 generally extend in a direction away from respective fold lines 13, 15, 23, 25, 33, 35, 43, 45 toward periphery 8 of the blank. Further, in lieu of “panels,” the surfaces of carton 200 formed from the blank 5 can be referred to as “sides.”

Panel 10, at periphery 8, has a free front edge 16 with a curved, undulating shape forming a plurality of convex lobes or projections 17. Although three projections 17 are shown in FIG. 1, greater or fewer numbers of projections are also possible. Additionally, a variety of different undulating and/or projecting shapes may be used. For example, a single projection may extend along a majority of the length of the bottom panel, and the front edge 16 may be straight, rather than undulating, at the projection. End flap 14 has a first concave free edge 49 that extends between a first end of the front edge 16 and a free edge 93 of end flap 14. End flap 14 also has a second concave free edge 59 that extends between an intersection point of the fold lines 11, 25 and free edge 93. End flap 12 has a first concave free edge 9 that extends between a second end of the front edge 16 and a free edge 91 of end flap 12. End flap 12 further includes a second concave free edge 19 that extends between an intersection point of the fold lines 11, 23 and free edge 91.

End flap 34 has a first concave free edge 69 that extends between an intersection point of fold lines 21, 25 and free edge 94 of end flap 34. End flap 34 also has a second concave free edge 79 that extends between an intersection point of the fold lines 31, 45 and free edge 94. End flap 32 has a first concave free edge 29 that extends between an intersection point of the fold lines 21, 23 and free edge 92 of end flap 32. End flap 32 further includes a second concave free edge 39 that extends between an intersection point of the fold lines 31, 43 and free edge 92.

A projection 78 extends slightly from panel 30 across fold line 31 into panel 40, and is configured to form a stand or similar formation to help support carton 200 in an upright configuration, such as when carton 200 is disposed on a surface, such as a shelf. A central cutout or opening 80 is also provided in panel 20. While opening 80 could be covered by a flap (not shown), generally, opening 80 is defined by a perimeter 82 surrounding a void 84. The opening 80 is shown in FIG. 1 as a bottle-shaped cutout or opening, though other shapes are within the scope of the invention. The opening 84 may optionally be covered or backed with a film, such as polyfilm or cellofilm. Generally, the opening 84 provides for viewing contents in the interior of the carton to allow, for example, evaluation of product remaining in the enclosed carton without separating the dispensing panel.

A dispensing feature 70 is formed in panel 30 and extends across fold line 31 and into panel 40 as shown in FIG. 1. Specifically, the dispensing feature 70 is defined by a cut line 71 that forms a projection 77 and a pattern of tear lines, including tear lines 72, 73, 74, 75. Tear lines 73 and 75 extend along and generally collinear with respective lines of disruption 33 and 35. Tear line 73 extends from the intersection of fold line 21 with line of disruption 33 to segment line 27 and then intersects with tear line 72, which extends in a generally oblique direction to, or proximate to, cut line 71. Tear line 75 extends from the intersection of fold line 21 with line of disruption 35 to segment line 37 and then intersects with tear line 74, which extends in a generally oblique direction to, or proximate to, cut line 71. Generally, tear lines 72, 73, 74, 75 and cut 71 effectively are connected in a generally continuous manner, to define, along with fold line 21, a dispensing panel 95.

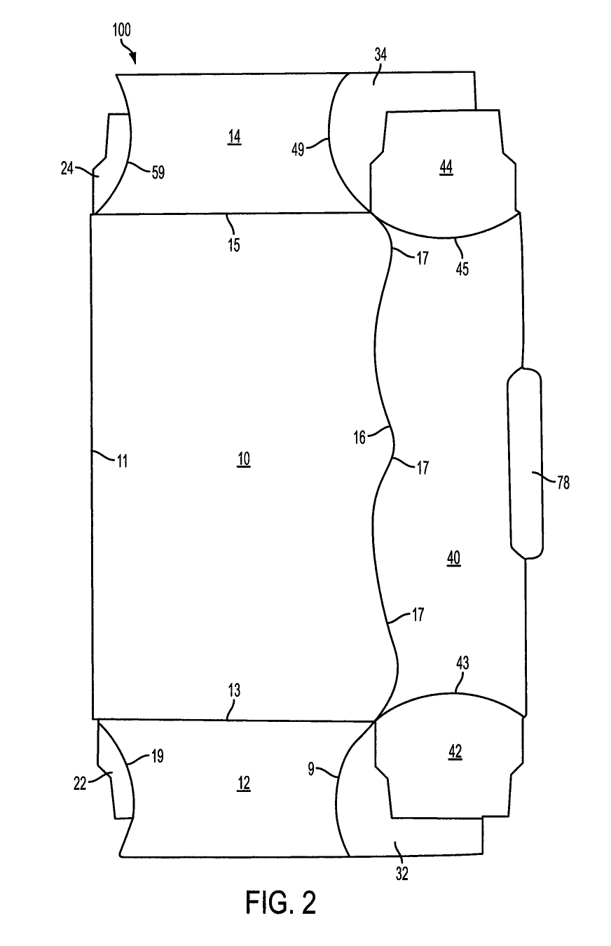

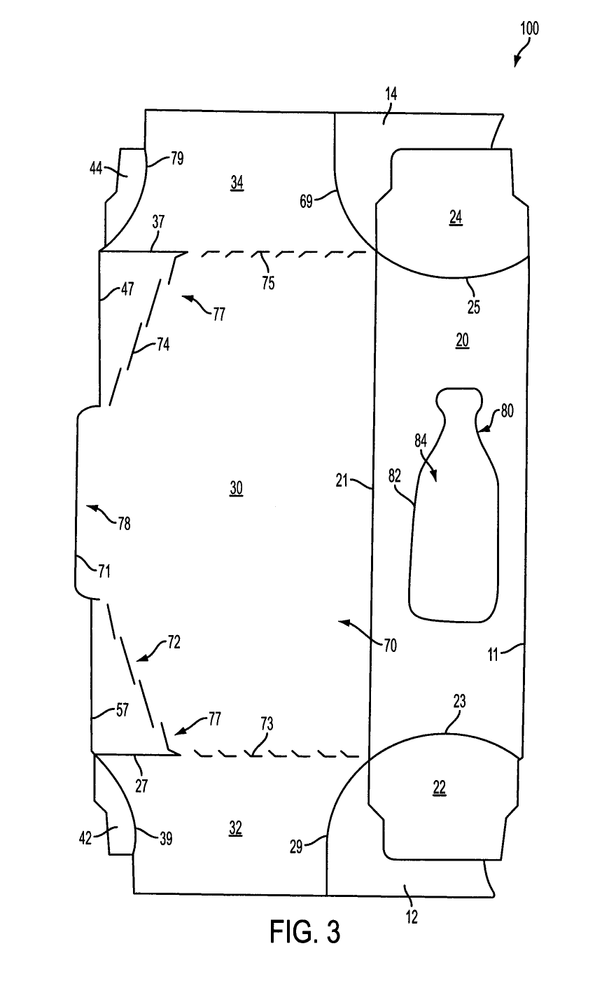

FIGS. 2 and 3 show plan views of the blank 5 folded into a preform 100 in a substantially flat shipping configuration prior to erecting the carton 200. In the shipping configuration, panel 40 acts as a front panel and adhesive panel 50 acts as a bottom closure panel, and panels 40 and 50 are folded along the fold line 31 approximately 180 degrees with respect to panel 30, with the outer faces of the front panel 40 and the bottom closure panel 50 facing outwardly. Panel 10 here acts as a bottom panel and is folded along the fold line 11 approximately 180 degrees with respect to the panel 20 so as to overlap the inner face of the panel 20, a portion of the inner face of the panel 30 (which acts as a top panel in this configuration) and the outer face of the adhesive panel 50. The bottom panel 10 may be adhesively or otherwise attached to adhesive panel 50, thereby forming a substantially flat carton preform.

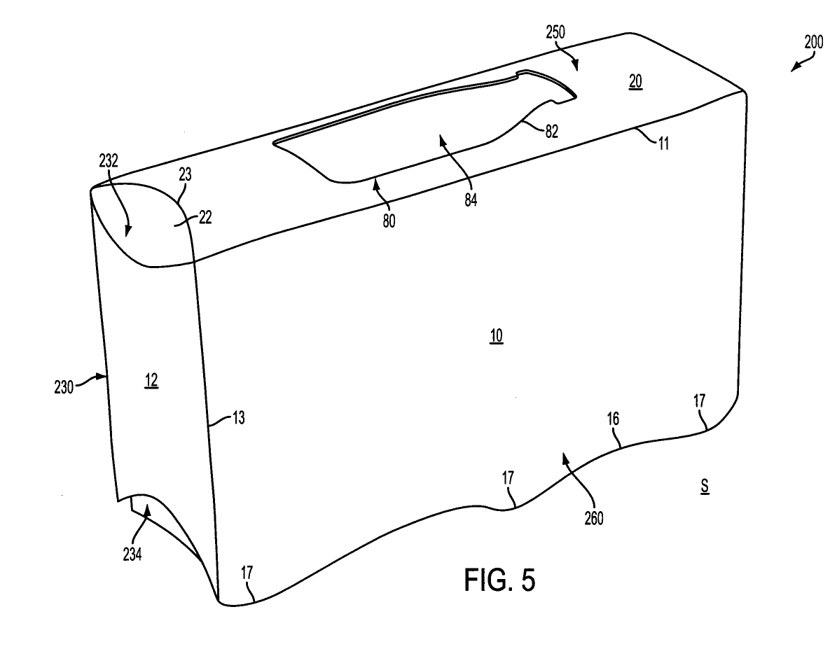

FIGS. 4 and 5 show a carton 200 erected to a closed configuration from blank 5 or from preform 100 shown in FIGS. 2 and 3. The steps in the described process(es) are not limited to the sequence in which they are described, and may be performed in a number of different sequences. Prior to closing at least one of the panels or end flaps of the carton, such that an opening remains in the structure formed by the blank 5 (FIG. 1) to allow access to the interior of the structure) the interior of the folded blank 5 or the preform 100 may be loaded with desired contents, product(s), or articles.

The blank 5 may be folded open from the configuration of FIGS. 2 and 3 by folding the blank 5 along fold lines 11, 21, 41 and fold line 31 such that the bottom and top panels 10, 30 extend substantially parallel to each other, and the rear and front panels 20, 40 extend substantially parallel to each other between the bottom and top panels 10, 30, with the rear and front panels 20, 40 extending substantially perpendicularly to the bottom and top panels 40, 20. Specifically, panels 30, 50 may be folded along the fold lines 31, 41, respectively, so as to extend rearward from panel 40. Panel 20 may be folded along the fold line 21 to extend substantially parallel to panel 40 and panel 10 may be folded along fold line 11 to be substantially perpendicularly to the panel 30. The adhesive panel 50 may be folded along fold line 41 to extend substantially parallel to panel 10. Adhesive panel 50 may be attached to the inner or outer side of panel 10 by adhesive or other suitable attachment means.

During a folding sequence, the end flaps are folded toward the interior, with either the top end flaps or the base end flaps folded inward first. At end 4, end flap 22 and end flap 42 may be folded inwardly along the arcuate fold lines 23, 43, respectively, so as to extend substantially perpendicularly to the rear and front panels 20, 40. End flap 32 may be folded downwardly along the tear line segment 73 and the fold line 27 to at least partially overlap end flap 22 and end flap 42, and to extend substantially perpendicularly to the bottom and top panels 10, 30. End flap 12 may be folded upwardly along the fold line 18 to at least partially overlap end flap 22, end flap 42 and end flap 32. It is noted that the configuration of end flap 12 and end flap 32 may be reversed such that end flap 32 at least partially overlaps end 12. End flap 12 and end flap 32 may be adhesively or otherwise attached to each other, thereby forming a second side panel 230 including the end flap 22, end flap 42, end flap 32, and end flap 12. End flap 22 and the end flap 42 may not be adhesively attached to end flap 12 and end flap 32, such that end flap 12 and end flap 32 are laterally spaced from end flap 22 and end flap 42, thereby forming a second rear handle opening 232 and a second front handle opening 234 in the second side panel 230. At end 6, end flap 24 and end flap 44 may be folded inwardly along the arcuate fold lines 25, 45, respectively, so as to extend substantially perpendicularly to the rear and front panels 20, 40. End flap 34 may be folded downwardly along the tear line segment 75 and the fold line 37 to at least partially overlap the end flap 24 and the end flap 44, and to extend substantially perpendicularly to the bottom and top panels 10, 30. End flap 14 may be folded upwardly along the fold line 15 to at least partially overlap end flap 24, end flap 144 and end flap 34. It is noted that the configuration of the end flap 14 and end flap 34 may be reversed such that end flap 34 at least partially overlaps end flap 14. End flap 14 and end flap 34 may be adhesively or otherwise attached to each other, thereby forming a first side panel 220 including end flap 24, end flap 44, end flap 34, and end flap 14. End flap 24 and end flap 44 may not be adhesively attached to the end flap 14 and the end flap 34, such that end flap 14 and the end flap 34 are laterally spaced from end flap 24 and end flap 44, thereby forming a first rear handle opening 222 and a first front handle opening 224 in the first side panel 220.

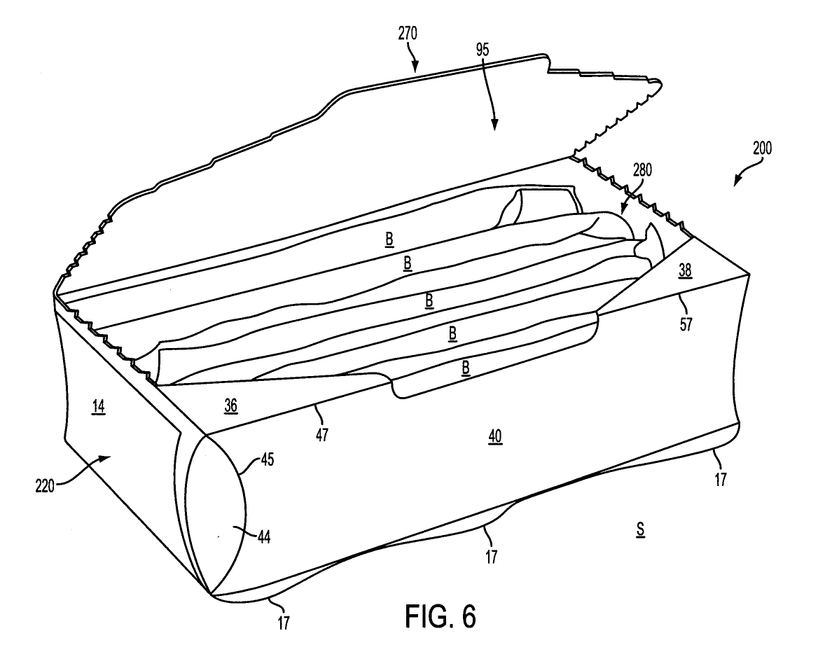

Still referencing FIGS. 4 and 5, the carton 200 formed by the exemplary process provided above is generally parallelepipedal and includes, in an erected configuration of carton 200, panel 10 that forms bottom panel 260, panel 20 that forms rear panel 250, panel 30 that forms top panel 210, panel 40 that forms front panel 240, end flaps 14, 24, 34, 44 that form first side panel 220, and end flaps 12, 22, 32, 42 that form second side panel 230. As shown in FIG. 4 and FIG. 6, the at least partially detachable panel section 95 forms a lid 270 that is at least partially detachable from the top panel 30 for dispensing the articles B. The lid 270 is configured such that the tab 78 in the panel section 95 protrudes forward beyond the front panel 40 to facilitate easy gripping by a person's hand for opening the lid 270 (FIG. 6).

As shown in FIG. 4, the lobes 17 (e.g., projections) on the front edge 16 of panel 10 extend forward beyond the front panel 40 by approximately the same distance that the tab 78 extends past the front panel 40. Thus, when the carton is placed on support surface S, as shown in FIG. 5, with the front panel 40 facing downward toward support surface S, projections 17 and tab 78 form support members upon which the carton 200 can be disposed to stand. In addition to forming a stand, tab 78 forms an opening feature for opening the carton 200. The support members may be shaped differently, or one or more of them may be omitted.

Referring to FIG. 4, the arcuate fold lines 43, 45 form concave corners at the junctions of the side panels 220, 230 and the front panel 40. The first rear handle opening 222 and the first front handle opening 224 are formed in the first side panel 220 behind end flap 14 and end flap 34. As shown in FIG. 5, the arcuate fold lines 23, 25 form concave corners at the junctions of the side panels 220, 230 and the rear panel 20. The second rear handle opening 232 and the second front handle opening 234 are formed in the second side panel 230 behind end flap 12 and end flap 32. The concave corners facilitate gripping by a person's hand of the flaps 24, 44 and the flaps 22, 42 of the side panel 220 and the side panel 230, respectively, such as for the purpose of carrying or otherwise moving the carton 200. The corners may be shaped differently (e.g., the corners may be straight, conventional corners). The handle openings 222, 224, 232, 234 may be sized and configured to receive a persons fingers and/or thumbs therein to provide access to the flaps 24, 44, 22, 42, respectively.

As shown in FIG. 5, the opening 80 in panel 20 provides a window that renders the product, such as bars B shown in FIG. 6, visible from the exterior of the carton 200 when the carton is closed. The opening 80 may or may not be backed by a window film, such as polyfilm or cellofilm.

As shown in FIG. 6, when the carton 200 is resting on the support surface S with panel 10 facing downward, the lid 270 may be opened for dispensing product, such as bars B. The lid 270 may be opened by gripping tab 78, pulling tab 78 upwardly to detach at least partially the panel section 95 from the remaining top panel sections 36, 38 along the tear lines 72, 74, detaching along tear lines 73,75, and folding the lid 270 upwardly along the fold line 21 to expose a dispenser opening 280. The lid 270 may be reclosed or partially reclosed by folding the lid 270 downwardly along the fold line 21 to cover the dispenser opening 280. Articles, such as for example, bars B as shown in FIG. 6 may be placed inside the carton 200 prior to forming one or both of the side panels 220, 230.

The blank and carton formed can be of any dimensions, which dimensions can be modified to receive, transport, and/or dispense different contents. For exemplary purposes only, the following dimensioning is provided for a blank that forms a carton. In the example embodiment, the blank can be approximately 6 to 12 inches in width (as measured from end flap 12 to end flap 14) and approximately 6 to 12 inches in length (as measured from projection 17 to panel 50), with the exemplary carton having a width of 8 3/16 inches and a length of 9.87 inches. The exemplary blank has a length of panel 10 of 3.18-inches, a length of panel 20 of 1 and ⅝ inches, a length of panel 30 of 2.94-inches, a length of panel 40 of 1 and ⅝ inches, and a length of panel 50 of ½-inch. The exemplary blank has a width of end flaps 14 and 34 of 1 and 15/32 inches, a width of panels 10 and 30 of 5¼ inches, a width of end flaps 12 and 32 of 1 and 15/32 inches, a width measured between flaps 22 and 24 across panel 20 of 7 and ⅜ inches, and a width measured between flaps 42 and 44 across panel 40 of 7 and ⅜ inches. A carton formed from this exemplary blank has an approximate size of 2.940 by 1 and ⅝ by 5¼ inches, has an approximate area of 68.03 inches, and has an approximate rule length of 94.597 inches. These dimensions are offered for exemplary purposes only and should not limit in any manner the scope of the invention or the claims.

In some instances in the foregoing, attaching parts together is described with reference to specific features and methods. However, the attaching may be carried out in any suitable manner, such as, but not limited to, through the use of adhesive material.

The term “line of disruption” is used in the specification. A line of disruption may be any suitable line, such as a fold line and/or tear line and/or cut line (e.g., a slit). The term “fold line” is used throughout the description. It is noted that, unless stated otherwise, the term “fold line” can include any at least somewhat line-like arranged, although not necessarily straight, form of weakening that facilitates folding therealong. More specifically, but not for the purpose of narrowing the scope of the present invention, conventional fold lines include: a crease, such as formed by folding; a score line, such as formed with a blunt scoring knife, or the like, which creates a crushed portion in the material along the desired line of weakness; a slit that extends partially into the material along the desired line of weakness, and/or a series of spaced apart slits that extend partially into and/or completely through the material along the desired line of weakness; or various combinations of these features. The term “tear line” is also used throughout the specification. A tear line can be any at least somewhat line-like arranged, although not necessarily straight, form of weakening that facilitates tearing therealong. More specifically, but not for the purpose of narrowing the scope of the present invention, conventional tear lines include a slit that extends partially into the material along the desired line of weakness, a series of spaced apart slits that extend partially into and/or completely through the material along the desired line of weakness, or any combination of these features.

Each of the above-described concave-shaped features may be shaped differently. For example, they may have different curved shapes, or straight shapes, or any other suitable shapes.

The foregoing disclosure provides illustrative embodiments of the invention and is not intended to be limiting. As understood by those of skill in the art, the overall invention encompasses other embodiments not specifically enumerated herein. For example, although the carton is shown in the form of a generally parallelepipedal box, it can alternatively be shaped differently, and likewise the various detachable sections, panel sections, panels, flaps, projections, support members, tabs and lobes described herein can be shaped and arranged differently.

What is claimed is:

1. A blank comprising:
a first panel connected along a first fold line to a second panel; a peripheral edge of the first panel including at least one end projection;
the second panel connected along a second fold line to a third panel;
the third panel connected along a first line of disruption to a fourth panel;
the fourth panel connected along a third fold line to an adhesive panel;
end flaps connected along a first end of the blank and along a second end of the blank; and,
a dispensing panel in the third panel defined by tear lines and a dispensing panel projection that extends across the first line of disruption into the fourth panel.

2. The blank of claim 1 wherein the end flaps include a first end flap at the first end connected along a first transverse fold line to the first panel, a second end flap at the second end connected along a second transverse fold line to the first panel, a third end flap at the first end connected along a first curved fold line to the second panel, a fourth end flap at the second end connected along a second curved fold line to the second panel, a fifth end flap at the first end connected along a second line of disruption to the third panel, a sixth end flap at the second end connected along a third line of disruption to the third panel, a seventh end flap at the first end connected along a third curved fold line to the fourth panel, an eighth end flap at the second end connected along a fourth curved fold line to the fourth panel.

3. The blank of claim 2 wherein the tear lines include a first tear line that extends along the second line of disruption and a second tear line that extends along the third line of disruption.

4. The blank of claim 3 wherein the tear lines include a third tear line that extends from the second line of disruption in the third panel in a first direction toward the dispensing panel projection and a fourth tear line that extends from the third line of disruption in the third panel in a second direction toward the dispensing panel projection.

5. The blank of claim 4 wherein the third panel includes two remainder portions including a first remainder portion defined between the third tear line, the first line of disruption, and the second line of disruption and a second remainder portion defined between the fourth tear line, the first line of disruption, and the third line of disruption.

6. The blank of claim 1 further comprising an opening formed in the second panel.

7. The blank of claim 6 wherein the opening is covered by a substantially transparent material.

8. A method of dispensing comprising:
providing a carton comprising a first panel connected along a first fold line to a second panel; a peripheral edge of the first panel including at least one end projection; the second panel connected along a second fold line to a third panel; the third panel connected along a first line of disruption to a fourth panel; the fourth panel connected along a third fold line to an adhesive panel; end flaps connected along a first end and along a second end; and, a dispensing panel in the third panel defined by tear lines and a dispensing panel projection that extends across the first line of disruption into the fourth panel;
folding the first panel, the second panel, the third panel, the fourth panel, and the adhesive panel along the first fold line, the second fold line, the first line of disruption, and the third fold line, respectively;
folding the end flaps to close the first end and the second end; and,
separating the dispensing panel along the tear lines to create a dispensing opening in the third panel.

9. The method of claim 8 wherein separating the dispensing panel includes lifting the dispensing panel projection in a direction away from the dispensing opening.

10. The method of claim 8 wherein the carton includes a viewing opening in the second panel; the viewing opening is covered by a substantially transparent material and allows viewing of the interior of the carton.

11. A carton comprising:
a first panel connected along a first fold line to a second panel; a peripheral edge of the first panel including at least one end projection;
the second panel connected along a second fold line to a third panel;
the third panel connected along a first line of disruption to a fourth panel;
the fourth panel connected along a third fold line to an adhesive panel;
a first end panel formed by end flaps connected along a first end and a second end panel along a second end;
a dispensing panel in the third panel defined by tear lines and a dispensing panel projection that extends across the first line of disruption into the fourth panel;
wherein the adhesive panel is connected to an underside of the first panel.

12. The carton of claim 11 wherein the third panel is connected to the first end panel along a second line of disruption and the third panel is connected to the second end panel along a third line of disruption.

13. The carton of claim 12 wherein the tear lines include a first tear line that extends along the second line of disruption and a second tear line that extends along the third line of disruption.

14. The carton of claim 13 wherein the tear lines include a third tear line that extends from the second line of disruption in the third panel in a first direction toward the dispensing panel projection and a fourth tear line that extends from the third line of disruption in the third panel in a second direction toward the dispensing panel projection.

15. The carton of claim 14 wherein the third panel includes two remainder portions including a first remainder portion defined between the third tear line, the first line of disruption, and the second line of disruption and a second remainder portion defined between the fourth tear line, the first line of disruption, and the third line of disruption.

16. The carton of claim 11 further comprising a viewing opening in the second panel; the viewing opening is covered by a substantially transparent material and allows viewing of the interior of the carton.

17. The carton of claim 11 wherein the at least one end projection and the dispensing panel projection are configured to form stands to support the carton in an upright configuration.

18. The carton of claim 11 wherein the first end and the second end are formed by end flaps connected to the first panel, the second panel, the third panel, and the fourth panel.

19. The carton of claim 18 wherein the end flaps connected to the second panel and the fourth panel are connected along curved fold lines.

20. The carton of claim 18 wherein the end flaps form a first handle at the first end and a second handle at the second end.
